(19) United States
(12) Patent Application Publication
(10) Pub. No.: US 2008/0192972 A1
(43) Pub. Date: Aug. 14, 2008

(54) Phasing plug for acoustic compression drivers

(76) Inventor: Vernon Lewallen, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/705,911

(22) Filed: Feb. 13, 2007

(51) Int. Cl. H04R 1/20

(52) U.S. Cl. 381/343

(57) ABSTRACT

A phasing plug for use in a compression driver is configured with a central sound absorbing region that absorbs phase-distorted sound waves produced by an adjacent region of a vibrating diaphragm. The phasing plug is constructed from a plurality of generally hollow frusto-conical rings and a central conical element. The central conical element serves as a sound absorption region for absorbing phase-distorted sound waves. The phasing plug has a plurality of annular inlet apertures that permit sound waves to enter the phasing plug and traverse to an outlet region of the phasing plug. The outlet region is further enhanced by a plurality of wave guide rings that focus the exiting sound waves in a unified direction resulting in the dynamic reproduction and delivery of coherent high-frequency sound waves over a greater distance.

### FIELD OF THE INVENTION

The present invention relates to electro-acoustic loudspeakers typically known as compression drivers and, more particularly, to an improved phasing plug for use in such compression drivers.

### BACKGROUND OF THE INVENTION

Compression drivers transform electrical signals into sound by actuating an internal semi-spherical diaphragm which in turn compresses air that is located between the diaphragm and a phasing plug to produce sound waves. A compression driver is designed to increase the efficiency of a loud speaker by compressing the acoustical energy and transferring it through a channel to the throat of a horn. The compression driver is equipped with a semi-spherical diaphragm which vibrates in response to electrical signals. The electrical signals are applied to a voice coil that is attached to the edge of the diaphragm. The voice coil is arranged such that the coil is concentric with the diaphragm and is immersed in a magnetic field.

Most compression drivers have a phasing plug that is positioned adjacent to the diaphragm and has a corresponding semi-spherical input surface. The phasing plug is spaced away from the diaphragm so that there is no interference between the phasing plug and the diaphragm. The phasing plug forms the acoustical channel or pathway from the diaphragm to the throat of the horn. The purposes of the phasing plug are to compress the sound waves and to equalize the acoustic path lengths to thereby minimize high frequency distortions caused by phase cancellations, phase shifts and phase differentials.

The phasing plug typically has a first surface that faces the diaphragm and a second surface facing the throat of a horn. Formed within the phasing plug are typically several acoustical pathways or apertures. In the past, numerous attempts have been made to optimize the phasing plug's acoustical pathways, such as by providing annular rings forming circumferential slits, by providing wedge-type sections forming radial slits, or by providing hole arrays, that transfer the sound energy from the diaphragm to the throat. These prior attempts have not produced satisfactory results in transforming the sound waves generated by the diaphragm without high frequency interference or distortion.

Compression drivers comprising a traditional diaphragm coupled with known phasing plugs thus suffer from phase distortions that distort high frequency sound waves. The high fidelity sounds are suppressed and high quality reproduction of voice and music are not adequately obtained because phase distortions are produced by the sound waves emanating from the various portions of the diaphragm. The sound waves usually traverse paths of unequal length in passing to the throat of the horn so that the sound waves propagated from the diaphragm do not reach the throat in phase coherent form.

As a result, currently available compression drivers usually require substantial electronic equalization by way of sound conditioning equipment. This electronic sound conditioning frequently causes the compression driver to be actuated at high power levels. This often results in overheating of the voice coil, which in turn reduces the operational life span of the compression driver.

Therefore, one objective of the present invention is to provide a new and improved phasing plug which can provide increased sound clarity with minimal acoustic distortion.

A further objective of the present invention is the provision of a new and improved phasing plug that has an enhanced frequency range and increased dynamic performance.

Yet another object of the present invention is to provide a new and improved phasing plug that reduces the requirement for excessive active equalization and increases the operational life span of the compression driver.

Therefore, there remains an unmet need for an enhanced phasing plug that reproduces accurate high frequency sound waves without a need for excessive electronic equalization of the electrical actuation signals of the compression driver.

### SUMMARY OF THE INVENTION

The present invention comprises a compression driver phasing plug. In a preferred configuration, the phasing plug reduces harmonic distortions caused by phase coherency anomalies.

In a preferred embodiment, a phasing plug is provided for use in an acoustical compression driver. The phasing plug comprises a central wave guide member, at least intermediate wave guide member and a bottom wave guide member. The central wave guide member further includes a sound wave absorbing insert that forms a central sound wave absorbing region. The spaces between the wave guide members form a plurality of sound wave pathways and thus in combination create a sound wave inlet region. Preferably, the sound wave absorption region and sound wave inlet region are adjacent and correspond to a phase distortion zone and a phase coherent energy zone of the compression driver's diaphragm.

In another embodiment the invention provides a phasing plug for use in a compression driver comprising a sound wave inlet region having a plurality of inlet apertures and an outlet throat region having a plurality of annular outlet apertures. The phasing plug has a central wave guide member having a first end and a second end, in which the first end has an integral recess formed therein. A sound absorbing material is inserted into the integral recess of the central wave guide member. The phasing plug further comprises at least one intermediate wave guide member and a bottom wave guide member. The central wave guide member, intermediate wave guide member and bottom wave guide member are disposed one within the other and co-axially aligned with the central wave guide member in a spaced apart relationship that forms a plurality of sound wave pathways there between. The sound wave pathways extend from the sound wave inlet region to the outlet throat region of the phasing plug.

In another variation of the invention comprises a compression driver system having a phasing plug disposed between a throat of a bottom plate and a diaphragm of the compression driver. The phasing plug has a central wave guide member that includes a sound absorbing insert received into an integral recess formed on a first end of the central wave guide member. The phasing plug further comprises at least one intermediate wave guide member and a bottom wave guide member, by which each member is sized for co-axially insertion one within the other in a spaced apart relationship. The phasing plug has a sound wave pathways formed between the central wave guide member and the intermediate wave guide member. Correspondingly, the intermediate wave guide member and the bottom wave guide member form another sound wave pathway between them. The sound pathways extend from a sound wave inlet region adjacent to the diaphragm to an outlet throat region adjacent to the throat.

Similarly, another variation comprises a compression driver system including a phasing plug disposed between a throat of a bottom plate and a diaphragm of the compression driver. This variation includes a phasing plug having a sound wave inlet region formed upon the outer circumferential surface area of the phasing plug and a sound wave absorption region formed upon the remaining central surface area of the phasing plug, A plurality of sound wave pathways are formed within the sound wave inlet region. The sound wave pathways extend from the sound wave inlet region adjacent to the diaphragm to an outlet throat region adjacent to the throat. In this variation the diaphragm has a phase coherent energy zone that is located adjacent the sound wave inlet region and a phase distortion zone located adjacent the sound wave absorption region. As a result the sound waves generated by the phase coherent energy zone enter the sound wave inlet region and sound waves generated by the phase distortion zone are absorbed by the sound wave absorption region.

In other embodiments of the invention, several elements or components may be modified or have alternate constructions. In one alternate embodiment, the sound absorbing insert may further comprise a plurality of sound absorption grooves formed there upon or be fabricated from materials such as rubber, cork or high-density foam. Additionally, the phasing plug may include a wave guide array integrally formed with the outlet region. It is also contemplated that the sound wave pathways volumetrically expand from the inlet apertures to the annular outlet apertures of the phasing plug and this volumetric expansion may be exponential. In a preferred construction, the phasing plug has a central wave guide member, a intermediate wave guide members and a bottom wave guide member that are fabricated from a phenolic material. The bottom wave guide member may further comprise a wave guide surface circumferentially formed upon the outer diameter of a first end of the bottom wave guide member.

In another variation, the phasing plug includes a sound absorbing insert and a first end of said central wave guide member that form a sound wave absorption region that occupies approximately the center ⅓ surface area of the phasing plug. Correspondingly, the sound wave inlet region occupies the remaining outer ⅔ circumferential ring area of the phasing plug.

The phasing plug of the present invention provides numerous advantages over current phasing plugs and has particular advantages when used with a compression driver. The sound wave absorbing portion or region of the phasing plug absorbs phase distorted sound waves and at the same time, the phasing plug transmits coherent sound waves, such as coherent low and midrange sound waves and sound waves generated at the outer edges or exterior portions of the diaphragm. As a result the phasing plug transmits sound with increased clarity over the high-frequency range, while at the same time, maintaining audible definition over the high to midrange sound wave spectrum.

The improved phasing plug reduces the need for electronic signal processing or equalization of the input signals to the compression driver and thus avoids over-heating of the voice coil resulting in energy conservation and increased compression driver. Since the use of the improved phasing plug requires less signal processing, the compression driver is less likely to be over-powered by associated signal conditioners. The phasing plug of the present invention reduces over-heating and conserves energy used by the compression driver because the sound wave transmission is inherently free from typical phase distortions and excessive electronic equalization is unnecessary.

Additionally, the phasing plug also provides a focused sound wave projection by use of the wave guide rings at the termination point of each sound wave pathway. The wave guides facilitate the directional aiming of the sound waves. This directional aiming causes the sound waves to exit the throat region of the phasing plug on concentric and distinct pathways resulting in high-frequency (19 khz) waves that propagate in unison and are projected over greater distances.

Further objects, features, and advantages of the present invention over the prior art will become apparent from the detailed description of the preferred embodiments which follows, when considered with the accompanying figures.

### BRIEF DESCRIPTION OF THE DRAWINGS

FIG. 1 is an exploded isometric view of a compression driver including an improved phasing plug in accordance with a first embodiment of the invention;

FIG. 2 is an isometric view of a phasing plug in accordance with a first embodiment of the invention as viewed from above;

FIG. 3 is an isometric view of a phasing plug in accordance with a first embodiment of the invention as viewed from below;

FIG. 4 is an exploded isometric view of a phasing plug in accordance with a first embodiment of the invention;

FIG. 5 is an exploded isometric sectional view of a phasing plug in accordance with a first embodiment of the invention taken along line 5-5 illustrated in FIG. 4;

FIG. 6 is a sectional view of a collapsed compression driver assembly of FIG. 1, taken along line 6-6;

FIG. 7 is an enlarged sectional view of a portion of the compression driver illustrated in FIG. 6;

FIG. 8 is a isometric view of a phasing plug in accordance with a second embodiment of the invention as viewed from above;

FIG. 9 is a isometric view of a phasing plug in accordance with a second embodiment of the invention as viewed from below;

FIG. 10 is an exploded isometric view of a phasing plug in accordance with a second embodiment of the invention;

FIG. 11 is an exploded isometric sectional view of a phasing plug in accordance with a second embodiment of the invention taken along line 11-11 illustrated in FIG. 10;

FIG. 12 is a sectional view of a collapsed compression driver assembly of FIG. 1, taken along line 6-6 in accordance with a second embodiment of the invention;

FIG. 13a is an impedance vs. frequency graph illustrating the performance of a traditional phasing plug;

FIG. 13b is an impedance vs. frequency graph illustrating the performance of a phasing plug in accordance with the present invention; and

FIG. 13c is an impedance vs. frequency graph comparing the performance of the present invention with a traditional phasing plug.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

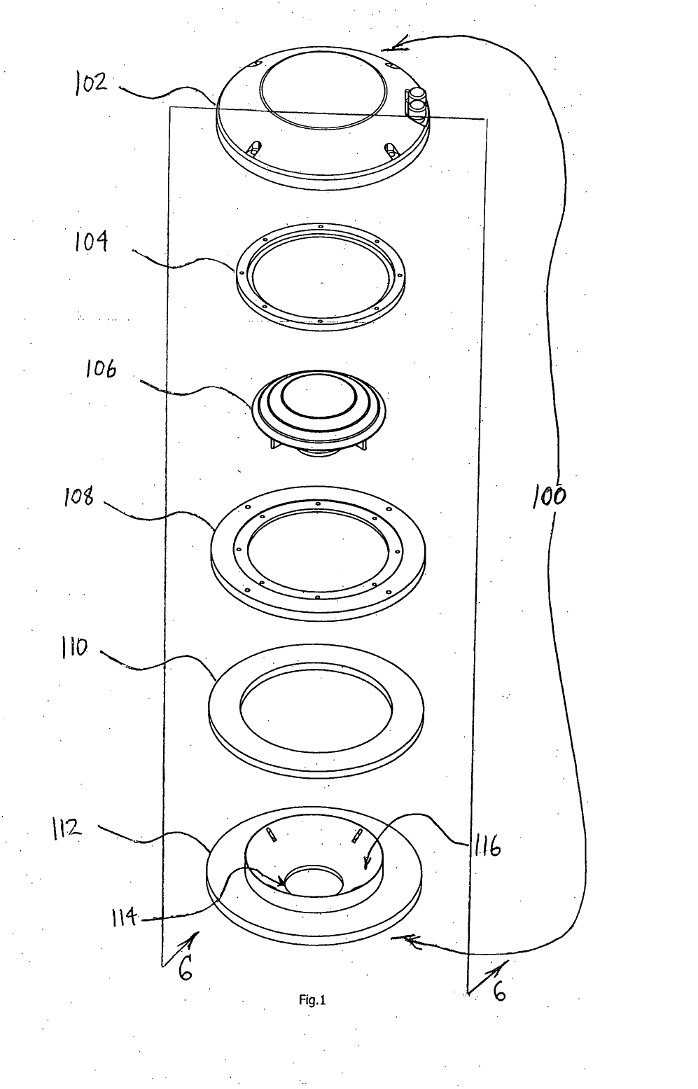

FIGS. 1 illustrates one embodiment of a compression driver in exploded assembly form. The compression driver comprises a cap 102 that provides both supportive structure and protection for the internal components of the driver. A semi-spherical diaphragm 104 with an integral voice coil (not shown) covers a phasing plug 106. The diaphragm 104 is secured to a top plate 108. The same top plate 108 also captures a permanent magnet 110 between it and a bottom plate 112. The phasing plug 106 is positioned between the bottom plate 112 and the diaphragm 104 and provides an acoustical conduit or pathway for sound waves to travel between the diaphragm 104 and a throat 114 integrally formed within the bottom plate 112. Preferably, the bottom plate 112 defines a phasing plug receiving cavity 116 configured to receive a portion of the phasing plug 106.

It will be appreciated that the phasing plug of the invention could be utilized in other driver configurations, including drivers where the components thereof have configurations other than that as illustrated. The particular sizes of the phasing plug and associated driver elements may vary, and the driver may itself be utilized in a plurality of applications.

The phasing plug 106 comprises a body which generally has a first or top side or surface and a bottom or second side or surface. These sides or surfaces are defined by one or more portions of the body. As detailed below, the body is preferably constructed from a plurality of assembled elements.

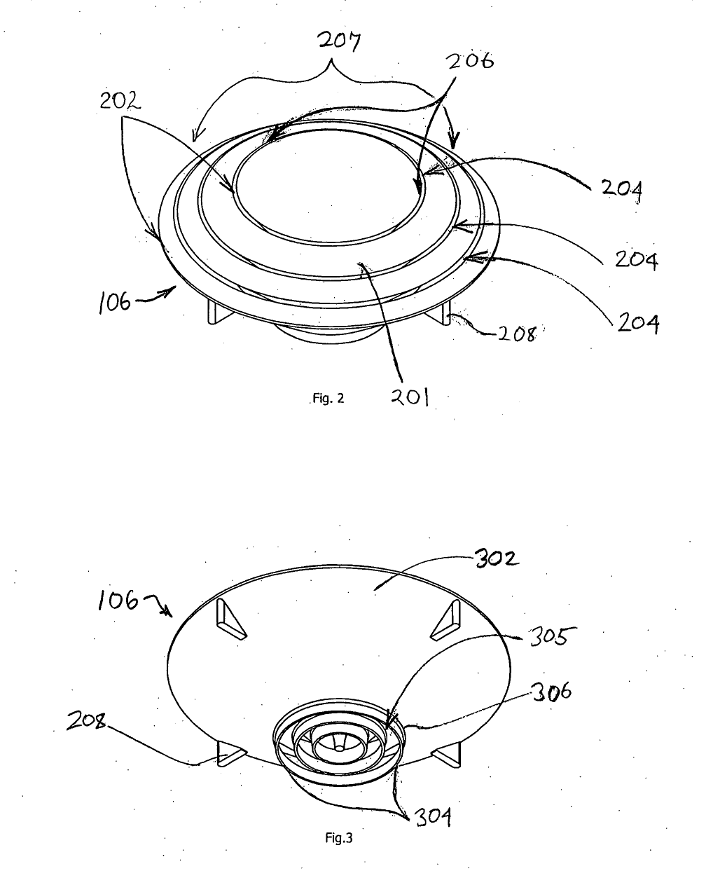

FIG. 2 is an isometric view of a phasing plug 106 in accordance with a first embodiment of the invention, as viewed the top. The top side or surface 201 of the phasing plug 106 has a sound wave inlet region 202. A plurality of inlet apertures 204 are defined in the inlet region 202. The inlet apertures 204 preferably comprise circumferential slits formed or defined between individual frustro-conical elements or members (discussed in greater detail below) of the phasing plug 106. As also shown in FIG. 2, the phasing plug 106 includes a central unwanted sound wave absorption region 206. The sound wave inlet region 202 and sound wave absorption region 206 together form a generally semi-spherical inlet region 207. In one specific version of the invention, the absorption region 206 comprises about ⅓ of the surface area of the inlet region of the phasing plug 106.

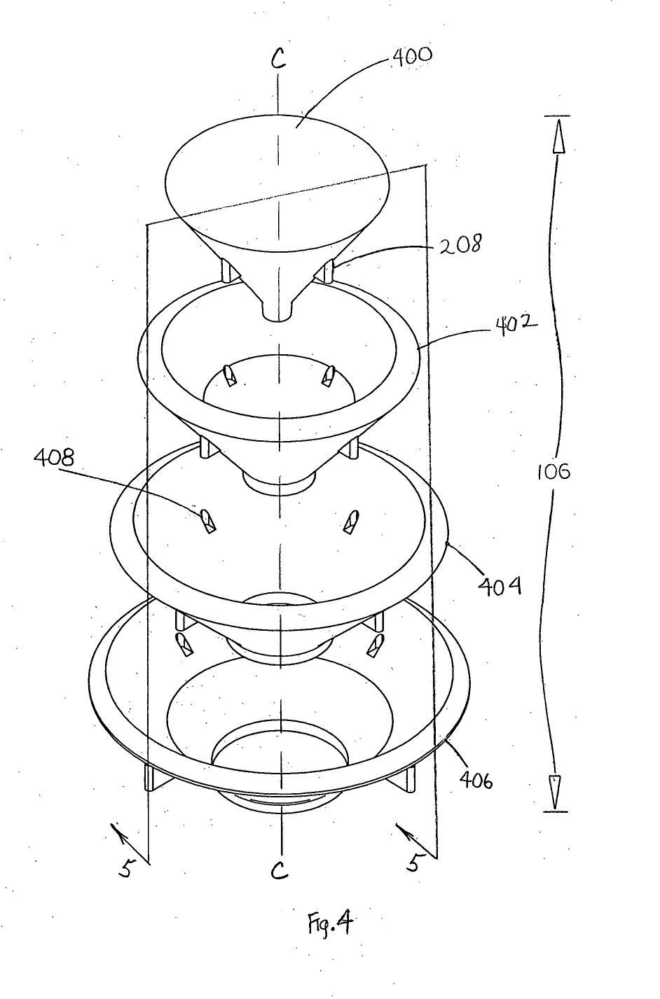

FIG. 3 is an isometric view of the phasing plug 106 in accordance with a first embodiment of the invention, as viewed from the bottom. As illustrated, the phasing plug 106 has a bottom side or surface 302. This side or surface 302 includes an outlet throat region 304. The throat region 304 preferably includes a wave guide array formed from a plurality of annular rings 306 that extend axially from a plurality of annular outlet apertures 305. The annular rings 306 combine to form a wave guide element associated with the throat region 304.

As detailed above, the phasing plug 106 may preferably be configured to be mounted to a lower plate 112 of a compression driver 100 (see FIG. 1). For this purpose, the phasing plug 106 may include one or more mounting bosses 208. These mounting bosses 208 extend outwardly from the bottom side or surface 302. In one embodiment, the bosses 208 are integrally formed with a portion of the body of the phasing plug 106 and define generally planar mounting surfaces. These surfaces are preferably configured to mount to the bottom plate 112. It is contemplated that the receiving cavity 116 may have mating recesses formed thereon for receiving and retaining the mounting bosses 208 of the phasing plug 106.

In one embodiment, the phasing plug 106 (or various portions or elements thereof) is fabricated using injection molding methods from a phenolic high-temperature bake-a-lite material or a high-density polymer plastic. It is contemplated that other materials may be used such as high impact polymers, resins, polycarbonates, metal alloys, and ceramics. Additionally, other suitable methods of manufacture may be implemented such as machining, casting, and thermo-forming.

One embodiment of the phasing plug 106 will be described in more detail with reference to FIG. 4. In one embodiment, the phasing plug 106 comprises a plurality of members or elements which are connected or associated with one another. As illustrated, the phasing plug 106 comprises a first, top or central wave guide member 400, a bottom or exterior wave guide member 406, and one or more (and preferably two), intermediate wave guide members 402, 404. As illustrated, the central wave guide member 400 is disposed at least partially within a first of the intermediate wave guide members 402, which first intermediate wave guide member 402 is disposed at least partially within the second intermediate wave guide member 404, which second intermediate wave guide member 404 is disposed at least partially within the bottom wave guide member 406, all of those members 400, 402, 404, 406 preferably being substantially co-axially aligned with one another.

The wave guide members 400,402, 404 and 406 are preferably arranged in a spaced relationship to one another. In one embodiment, mounting bosses or feet 208 extend from a bottom or outer surface of the central wave guide member 400 and each of the intermediate wave guide members 402,404 (as indicated above, such bosses or feet 208 also extend from the bottom wave guide member 406, which defines the bottom exterior of the phasing plug 106, as illustrated in FIG. 2). Top or inner surfaces of the intermediate and bottom wave guide members 402, 404 and 406 may define corresponding mounting recesses 408 for receiving the mounting bosses 208 of the central wave guide member 400 or intermediate wave guide member 402, 404, thereabove.

When assembled, the phasing plug 106 comprising the wave guide members 400, 402, 404 and 406 has a semi-spherical inlet region 207 (See FIG. 2) that preferably accurately corresponds to the shape and structure of the compression driver diaphragm 104 and an outlet throat region 304 (See FIG. 3).

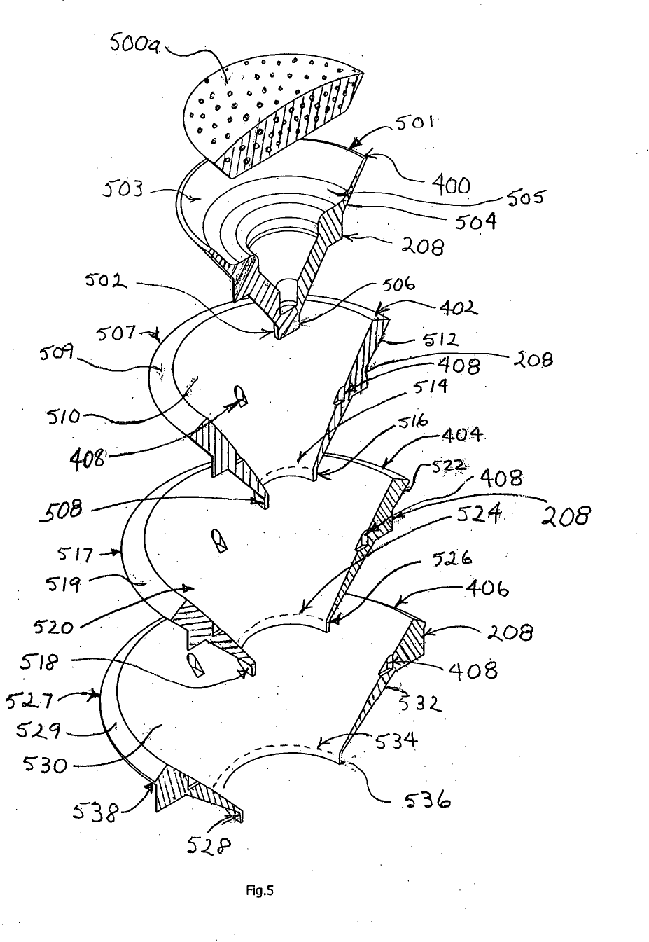

The various elements or members of the phasing plug 106 will be described in greater detail with reference to FIG. 5. In one embodiment, each of the members comprising the phasing plug 106 has several surfaces.

The central wave guide member 400 comprises a body which preferably has the form of an open cone having a top or first end 501 and a bottom or second end 502. The body has an inner surface 505 and an outer surface 504. The first end 501 of the central conical member 400 defines an opening or recess 503. The second end 502 is preferably closed. Being cone-shaped, the first end 501 has a greater size (diameter and circumference) than the second end 502. In a preferred embodiment, the second end 502 of the central wave guide member 400 defines an outlet wave guide protrusion 506 that axially extends from the conical termination point of the second end 502.

In a preferred embodiment, a sound absorbing insert 500A is received into the recess 503 at the first end 501 of the central wave guide member 400. The sound absorbing insert 500A comprises a body having a convex arcuate shaped top exterior surface that substantially corresponds to a concave shape of an adjacent portion of the diaphragm 104 (see FIG. 1). The insert 500A is preferably fabricated from a material well suited to absorb sound waves examples of such material are rubber, cork, high-density foam or other similar materials. The insert 500A is attached to the central wave guide member 400 within the recess 503, such as by using suitable adhesives such as an epoxy. However, it is contemplated that other methods may be used to connect or otherwise associate the insert 500A to or within the central wave guide member 400, such as mechanical fasteners, press-fit coupling or both. Additionally, a combination of adhesives and other methods/elements may be combined to connect the insert 500A to the central wave guide member 400.

In one embodiment, the first intermediate wave guide member 402 is generally frusto-conical in shape and has a first end 507, a second end 508, an inlet surface 509 at the first end 507, an interior surface 510 and an exterior surface 512. In the embodiment in which the first intermediate wave guide member 402 is generally frusto-conical, the member is larger in size (diameter and circumference, in this case) at the first end 507 than at the second end 508. Further, the first and second ends 507, 508 of the member 402 are open, thus defining a first open end and an outlet aperture 514. In one embodiment, an annular wave guide ring 516 extends axially from the outlet aperture 514.

In one embodiment, the first intermediate wave guide member 402 has a thickness comprising the distance between the inner surface 510 and outer surface 512. In one embodiment, the first end 507 is larger in diameter and is concentric with the second end 508, and forms an axially symmetrical frusto-conical member having a generally a tapering wall thickness from the first end 507 to the second end 508.

The inlet surface 509 preferably comprises a convex arcuate shaped inlet surface that substantially corresponds to the concave shape of an adjacent portion of the diaphragm 104. Preferably, the interior dimensions of the first intermediate wave guide member 400 are slightly larger than the exterior or outer dimensions of the central wave guide member 400 so as to accommodate a portion of the central wave guide member 400 therein.

The interior surface 510 of the first intermediate wave guide member 402 preferably comprises a substantially smooth surface. Formed into the inner surface 510 are one or more mounting recesses 408 configured to receive the one or more corresponding mounting bosses 208 of the central wave guide member 400. As described in more detail below, the interior surface 510 of the first intermediate wave guide member 402 and the exterior surface 504 of the central wave guide member 400 are positioned in a spaced apart relation that forms a sound wave pathway there between.

The exterior surface 512 of first intermediate wave guide member 402 similarly also preferably comprises a substantially smooth surface. Located at the exterior surface 512 are the above-described mounting bosses or feet 208 configured for insertion into corresponding mounting recesses 408 of the second intermediate wave guide member 404.

In similar arrangement to the first intermediate wave guide member 402 described above, the second intermediate wave guide member 404 is preferably also a frusto-conical shaped member having a first end 517, a second end 518, an inlet surface 519 at the first end 517, an interior surface 520, an exterior surface 522 and an outlet aperture 524 at the second end 518. Axially extending from the outlet aperture 524 is an annular wave guide ring 526. The second intermediate wave guide member 404 is preferably sized slightly larger than the first intermediate wave guide member 402 to receive at least a portion of the first intermediate wave guide member 402 therein.

The bottom or base wave guide member 406 is similarly preferably a frusto-conical shaped member having a first end 527, a second end 528, an inlet surface 529 at the first end 527, an interior surface 530, an exterior surface 532 and an outlet aperture 534 at the second end 528. Axially extending from the outlet aperture 534 is an annular wave guide ring 536. In one embodiment, the bottom wave guide member 406 is configured with a circumferential wave guide surface 538 that is formed at the exterior of the first end 527. In general, wave guide surface 538 is an extension area having an outermost surface which is generally parallel to the central axis of member 406. The bottom wave guide member 406 is preferably sized slightly larger than the second intermediate wave guide member 404 to receive at least a portion of that member therein.

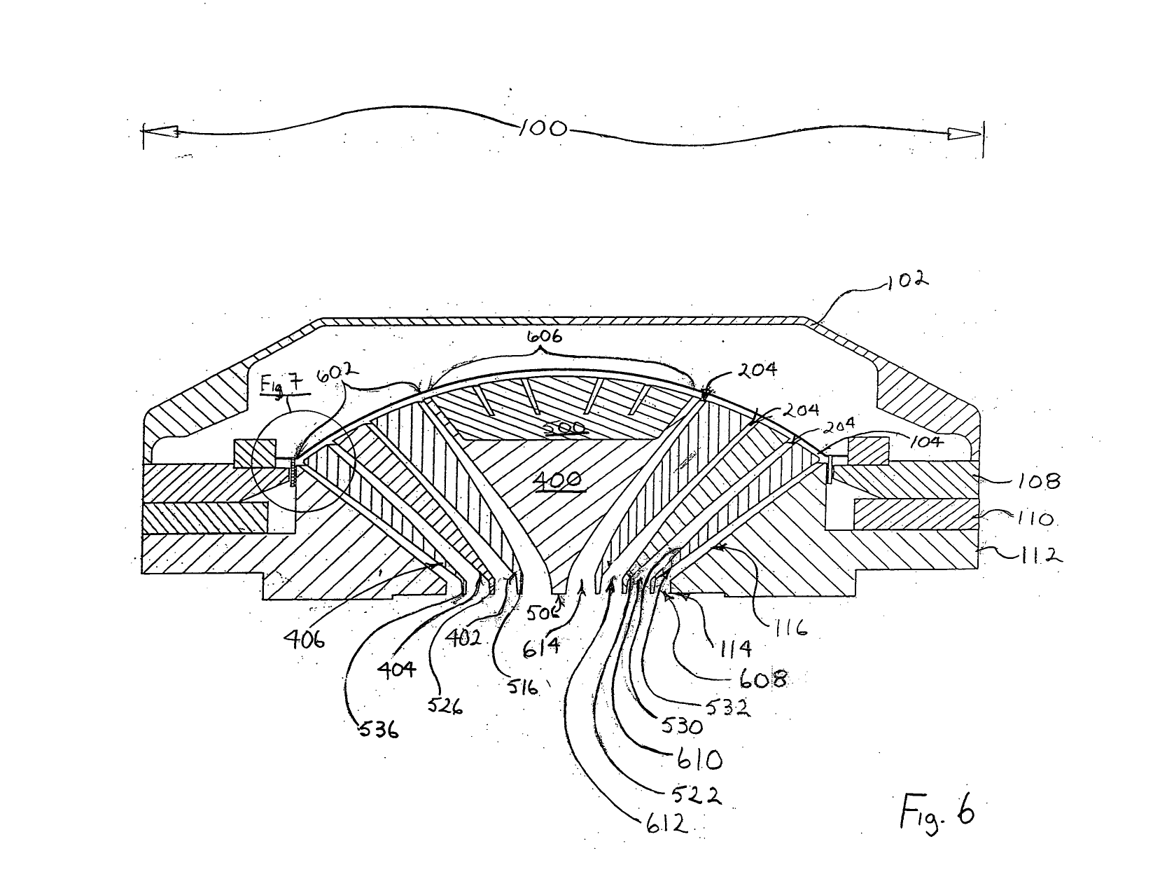

Additional details of the phasing plug 106 will now be described with reference to FIG. 6, which is a sectional view of an assembled compression driver 100 encapsulating a phasing plug 106 of the present invention. The compression driver 100 in operative form has a diaphragm 104 with a phase coherent energy zone 602 and a phase distortion zone 606. The phase coherent energy zone 602 is preferably positioned or located adjacent to the sound wave inlet region 202 of the phasing plug 106 (see FIG. 2). The phase distortion zone 606 is preferably positioned or located adjacent to the sound wave absorption region 206 of the phasing plug 106 (see FIG. 2). In operation, the phase coherent energy zone 602 generates phase coherent sound waves that are directed toward and received into the plurality of inlet apertures 204 of the sound wave inlet region 202 of the phasing plug 106. Correspondingly, the phase distortion zone 606 generates phase shifted or distorted sound waves that are directed toward and acoustically absorbed by the sound wave absorption region 206 of the phasing plug 106.

As best illustrated in FIG. 6, the central wave guide member 400 and the intermediate and bottom wave guide members 402, 404 and 406, in combination with the receiving cavity 116 of the bottom plate 112, provide or define a plurality of coaxial annular sound wave pathways 608, 610, 612 and 614. The sound wave pathways 608, 610, 612 and 614 extend from the inlet apertures 204 and converge toward the throat 114 of the bottom plate 112.

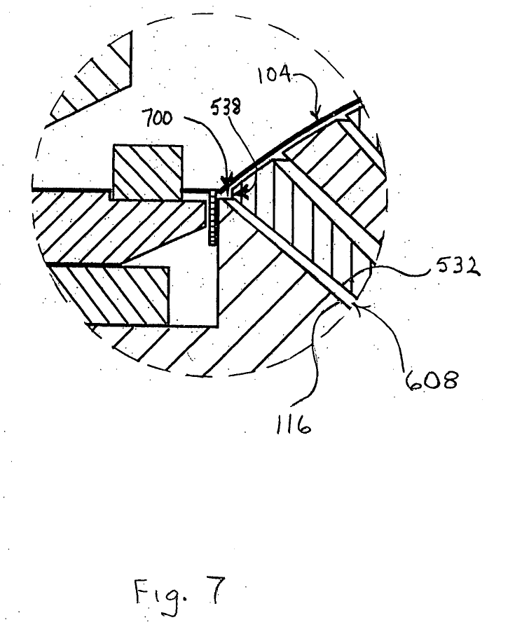

A first sound wave pathway 608 is an acoustical volumetric region formed between a surface of the bottom plate 112 which defines the receiving cavity 116 and the exterior surface 532 of the bottom wave guide member 406. This first sound wave pathway 608 begins at the inlet aperture 204 and volumetrically increases (preferably exponentially) toward the throat 114 of the bottom plate 112. In one embodiment shown in a combination of FIGS. 6 and 7, the inlet aperture 204 of this first sound wave pathway 608 includes the wave guide surface 538 that facilitates entry of sound waves generated by the vibrating diaphragm 104 into the first sound wave pathway 608. In operation, the wave guide surface 538 and inlet aperture 204 of the first sound wave pathway 608 combine to form an acoustical summing zone 700 that channels very high frequency sound waves generated by the diaphragm 104 into the phasing plug 106 and also provides a means for heat dissipation or cooling for the adjacently located diaphragm 104 and voice coil by circulating air around the summing zone.

Referring back to FIG. 6, a second sound wave pathway 610 is an acoustical volumetric region formed between the interior surface 530 of the bottom wave guide member 406 and the exterior surface 522 of the second intermediate wave guide member 404. Similar to the first wave guide pathway 608, the second wave guide pathway 610 begins at its corresponding inlet aperture 204 and volumetrically increases exponentially toward the throat 114 of the bottom plate 112. Likewise, third and fourth sound pathways 612 and 614 comprise acoustical volumetric regions formed between the interior and exterior surfaces of the first and second intermediate wave guide members 402, 404 and the central and first intermediate wave guide members 400, 402. In one embodiment the volume defined by the sound wave pathways 608, 610, 612 and 614 is acoustically tuned for a particular octave or frequency range.

Each sound wave pathway 608, 610, 612 and 614 is volumetrically proportioned to provide equal acoustic pathways for the sound waves generated by the vibrating diaphragm 104. Additionally, the individual volume of each sound wave pathway 608, 610, 612 and 614 preferably increases exponentially away from the diaphragm 104. This proportionality provides a plurality of sound wave pathways 608, 610, 612 and 614 of substantially equal acoustical lengths so that sound waves emanating from the diaphragm 104 traverse paths of substantially the same length and arrive at the throat 114 in phase coherent form. As a result, the sound waves are reproduced with increased uniformity and fidelity across a wide range of frequencies. In one specific embodiment the reproducible frequency range is from 600 Hz to 25 kHz. It will be appreciated that the volume of the pathways 608, 610, 612, and 614 may be controlled by the distance between members (by the spacing of the members and/or the taper of the surfaces thereof).

The annular wave guide rings 516, 526 and 536 of the first and second intermediate and bottom wave guide members 402, 404 and 406 and the outlet wave guide protrusion 506 of the central wave guide member 400, preferably terminate along a substantially common plane such as the bottom surface of bottom plate 112. The annular wave guide rings and protrusion are concentrically aligned and extend parallel to the central axis of each wave guide member. The wave guide rings and protrusion function together to uniformly direct and focus the sound waves from each sound wave pathway into the throat of a horn (not shown) coupled with the compression driver 100.

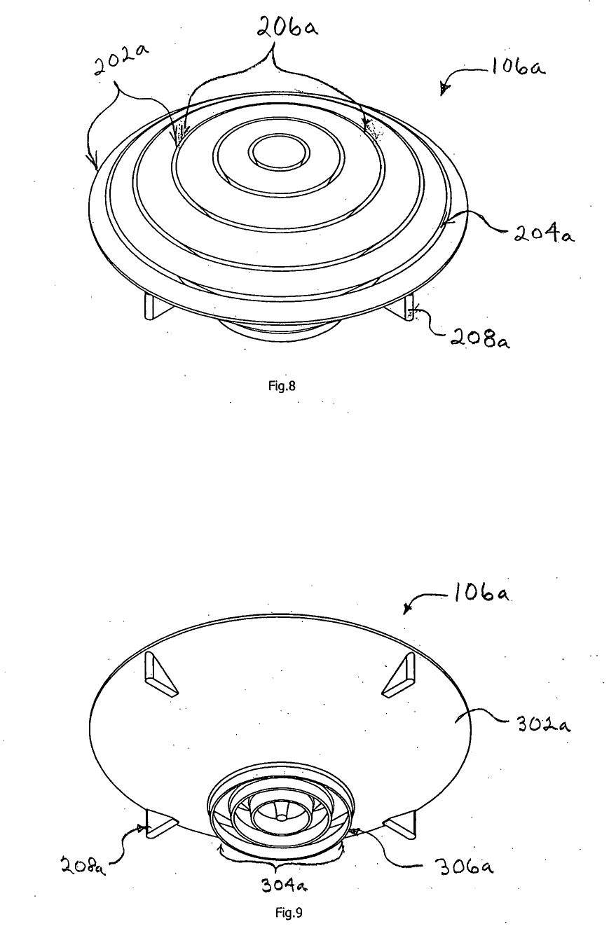

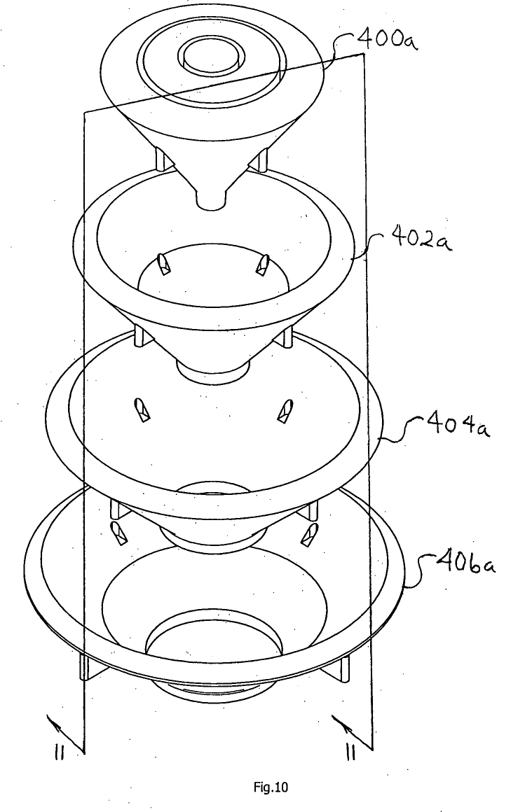

A phase plug 106A in accordance with another embodiment of the invention is illustrated in FIGS. 8-12. In these figures, like reference numerals have been utilized to designate like elements to the phase plug 106 illustrated in FIGS. 1-7 and described above, except that the reference numerals utilized to designate this embodiment have been assigned the alphabetical extension “A” or “B”. For example, the conical member 400 of the first embodiment is essentially the same as the conical member 400A of the second embodiment. This reference numeral designation scheme is utilized to avoid undue prolixity and avoid obscuring the invention and the alternate embodiment. The primary elements, as described above, have been designated in FIGS. 8-12, however not every surface or element is numbered for clarity.

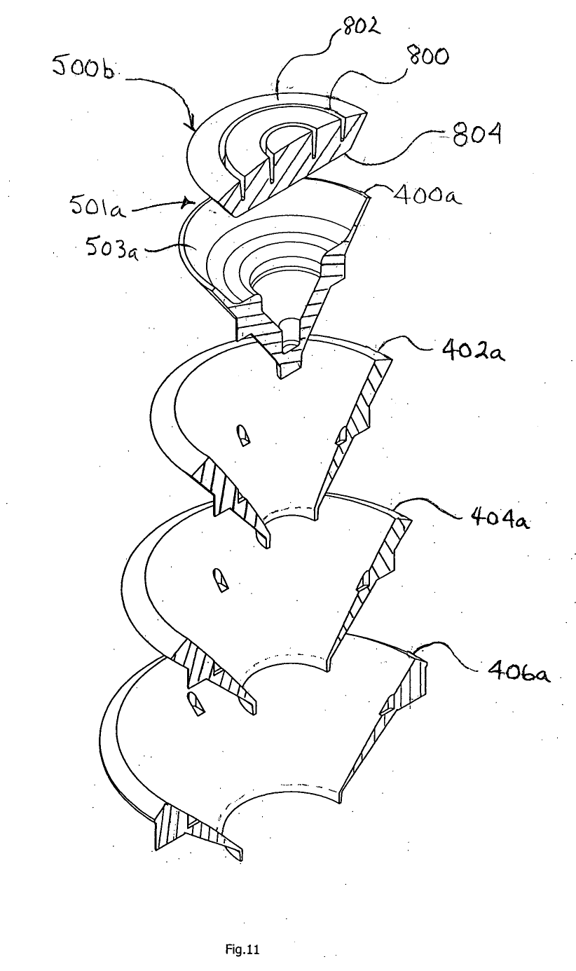

Reference is now made to FIGS. 8 and 11 which clearly illustrates an alternate embodiment phase plug 106A having sound absorption groves 800 formed within the sound wave absorption insert 500B. The grooves 800 provide enhanced sound wave absorption because the sound waves are permitted to penetrate deeper in to the absorption insert 500B and thus a greater volume of the insert 500B is used for sound wave absorption. Furthermore, the grooves 800 provide additional surface area for sound waves entering the insert 500B from various directions and angles. As best illustrated in FIGS. 11 and 12, the grooves 800 begin on the external surface 802 and extend partially into the insert 500B towards the inner surface 804.

The sound absorbing insert 500B is received into an integral recess 503A defined by a central wave guide member 400A. The sound absorbing insert 500B preferably comprises a convex arcuate shaped surface 802 that substantially corresponds to an adjacent concave portion of an adjacent diaphragm 104 (see FIG. 12). The insert 500B is preferably fabricated from a material well suited to absorb sound waves examples of such material are rubber, cork, high-density foam or other similar materials. The insert 500B is attached to the central wave guide member 503A, such as in the manner described above relative to the insert 500.

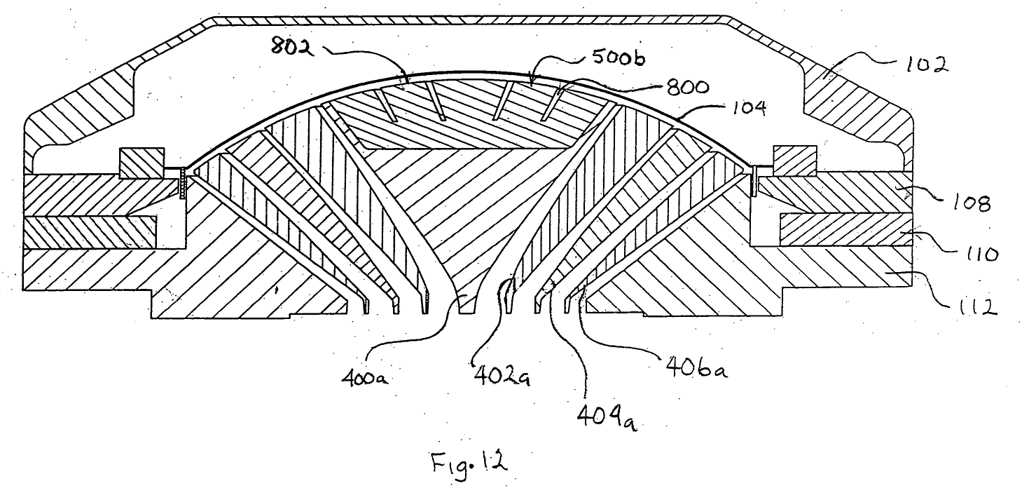

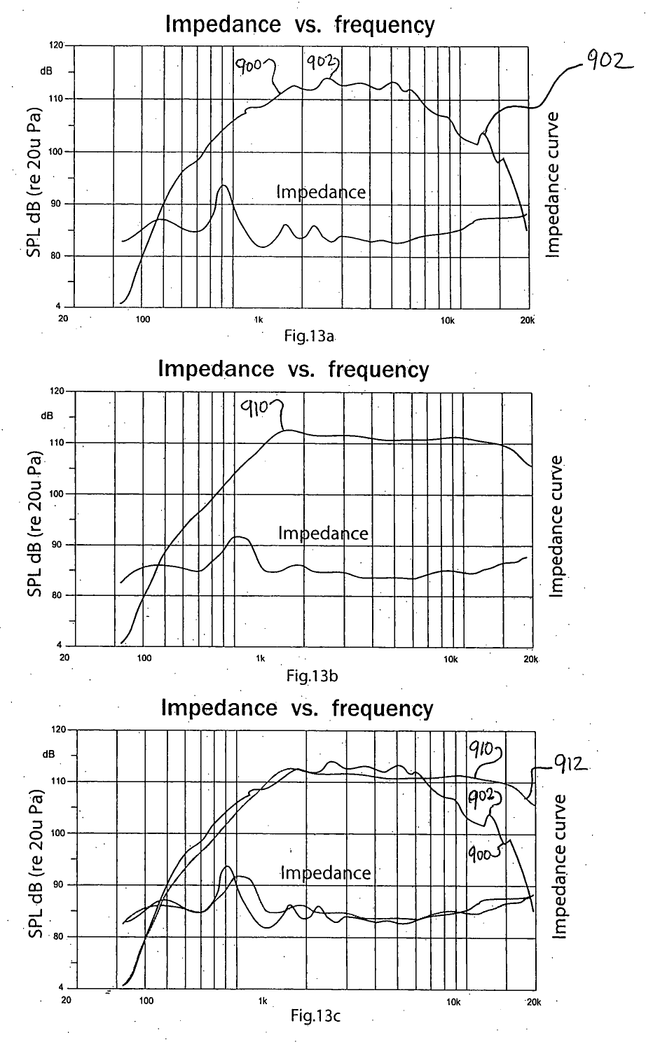

FIGS. 13a-13c are a series of impedance vs. frequency graphs comparing the performance of the present invention with a traditional phasing plug. In FIG. 13a, a first frequency curve 900 is based on sound performance of a traditional phasing plug is illustrated. As can be seen in the graph of FIG. 13a, the first curve 900 has several anomalies 902 that reflect phase distortions in the sound performance of the traditional phasing plug.

In comparison, FIG. 13b illustrates a second frequency curve 910 that is based on sound performance data for the improved phasing plug of the present invention. In contrast, the second curve 910 is generally flat and absent of such phase distortions.

As best illustrated in FIG. 13c, which combines the graphs of FIGS. 13a and 13b, the end regions (at high frequencies) of both curves are substantially different or divergent, as the first curve 900 representing the performance of the traditional phasing plug has a very steep drop-off and includes anomalies 902. In comparison, second curve 910 which represents the performance of the improved phasing plug of the present invention, has an anomaly free ending region having a gradual and smooth drop-off 912.

It will be appreciated that the phasing plug of the invention and a driver including a phasing plug in accordance with the invention may have other configurations than just as described and illustrated. For example, in one embodiment, the phasing plug may include a greater or lesser number of intermediate wave guide members depending upon the overall size of the phasing plug required for the compression driver. Thus a larger phasing plug may include three or more intermediate wave guide members, or as few as one (or zero) intermediate wave guide members.

The phasing plug (and the various portions or members thereof) may have other shapes than as illustrated. For example, the phasing plug could be oval rather than generally circular in shape.

As indicated, in one embodiment, the phasing plug may be constructed from a plurality of separate members. In yet another embodiment, the phasing plug may have a unitary or single piece construction. In this embodiment, the wave guide members may be manufactured as a single unit, such as with injection molding or casting methods.

In another variation, the phasing plug may be combined with one or more portions of the driver. For example, the central wave guide member, intermediate and bottom wave guide members might be fabricated as a single piece construction integrally formed with the driver bottom plate. Thus, the driver bottom plate and the phasing plug may be a single unitary element or portion of the compression driver. In an alternate variation of the unitary bottom plate/phasing plug element, the sound absorbing insert may be embedded during the fabrication of the bottom plate/phasing plug element or alternatively, the sound absorbing insert may be attached to the central wave guide recess in a separate subsequent process. The unitary bottom plate/phasing plug may be fabricated from various metals, alloys or polymers using several known manufacturing processes or methods such as injection molding, casting and machining to name a few.

In another embodiment, the wave guide members may be joined by other structural methods and still achieve the spaced apart relationship. For example, in place of having bosses and mating recesses, this embodiment may utilize flanges and slots, pins and holes, or tung and groves between the wave guide members.

As indicated above, in one embodiment, the sound wave inlet region of the phasing plug occupies or comprises about the outer ⅔ circumferential area of the phasing plug and corresponds to an adjacent phase coherent energy zone of the diaphragm, while the sound wave absorbing region occupies the center ⅓ circular surface area of the phasing plug and corresponds to an adjacent phase distortion zone of the diaphragm. In a preferred embodiment, the center or central ⅓ sound wave absorbing region is completely devoid of any sound wave inlets (i.e. the sound wave absorbing region extends radially outward from a center of the phasing plug a sufficient distance to comprise at least ⅓ of the total top area of the phasing plug (or about 0.8 of the radius of the phasing plug when the phasing plug is generally circular in shape), thus comprising a central circular area). In other embodiments, however, the size and shape of this region may vary. For example, the sound wave inlet region might comprise the outer ¾ and the sound wave absorbing region might comprise the center ¼ of the top surface area of the phasing plug.

In one embodiment, the sound wave absorbing region is sized and located relative to the diaphragm of the driver with which it is to be associated. In one embodiment, the sound wave absorbing region is sized to correspond to the central ⅓ area of the driver. In the case where the diaphragm and phasing plug are generally circular in shape, this area would extend outwardly from the center about the 0.8 of the radius of the diaphragm/phasing plug.

As indicated, the sound wave absorbing region is preferably a portion of the phasing plug which is designed to absorb, and thus not reflect or transmit, sound waves. The sound wave absorbing region may be defined by a plug which is located in a top or central wave guide member. In another embodiment, the sound wave absorbing region may comprise a portion of that top or central member (i.e. be formed integrally therewith). For example, the central wave guide member may be a unitary construction that is fabricated using a sound absorption material (e.g., cork, rubber or foam). In this example, the sound wave pathway surfaces may then be coated or laminated with a material that facilitates sound wave transmission. Conversely, the surfaces intended for sound wave absorption may remain un-coated and thus facilitate sound wave absorption upon those surfaces. The other wave guide members may be fabricated in a similar manner where the sound wave transmission surfaces are coated or laminated with materials that facilitate sound wave transmission.

The phasing plug of the present invention has numerous advantages over current phasing plugs and has particular advantages when used with a compression driver. In particular, the phasing plug produces enhanced sound quality by transmitting sound waves in phase coherent form. The sound wave absorbing portion or region of the phasing plug absorbs phase distorted sound waves (typically low to midrange frequency sound waves) generated at a central or center portion of a compression driver diaphragm. At the same time, the phasing plug transmits coherent sound waves, such as coherent low and midrange sound waves and sound waves (typically midrange to high frequency sound waves) generated at the outer edges or exterior portions of the diaphragm. This has the advantage that the phasing plug transmits sound with increased clarity over the high-frequency range, while at the same time, maintaining audible definition over the high to midrange sound wave spectrum.

The improved phasing plug also has the advantages that it reduces the need for electronic signal processing or equalization of the input signals to the compression driver, avoids over-heating of the voice coil and conserves energy. Since the use of the improved phasing plug requires less signal processing, the compression driver is less likely to be over-powered by associated signal conditioners. Over-powering or over-equalization is a frequent occurrence when using a traditional phasing plug with a compression driver, and such over-equalization has adverse impact upon the compression driver such as over-heating the voice coil and consuming excessive electrical power. The improved phasing plug of the present invention reduces over-heating and conserves energy used by the compression driver because the sound wave transmission is inherently free from typical phase distortions and excessive electronic equalization is unnecessary.

The improved phasing plug also provides a focused sound wave projection region by use of the wave guide rings at the termination point of each sound wave pathway. The annular rings and central protrusion provide a plurality of concentric wave guides that facilitate the directional aiming of the sound waves. This directional aiming causes the sound waves to exit the throat region of the phasing plug on concentric and distinct pathways resulting in high-frequency (19 khz) waves that propagate in unison and are projected over greater distances.

It will be understood that the above described arrangements of the apparatus and the method therefrom are merely illustrative of applications of the principles of this invention and many other embodiments and modifications may be made without departing from the spirit and scope of the invention as defined in the claims.

I claim:

1. A phasing plug for use in a compression driver comprising:
a sound wave inlet region having a plurality of inlet apertures;
an outlet throat region having a plurality of annular outlet apertures;
a central wave guide member, said central wave guide member having a first end and a second end, wherein said first end has an integral recess formed therein;
a sound absorbing insert received into said integral recess; and
at least one intermediate wave guide member and a bottom wave guide member, said central wave guide member, said intermediate wave guide member and said bottom wave guide member disposed one within the other and co-axially aligned with said central wave guide member in a spaced apart relationship that forms a plurality of sound wave pathways there between, said sound wave pathways extending from said sound wave inlet region to said outlet throat region of said phasing plug.

2. The phasing plug of claim 1, wherein the sound absorbing insert further comprises a plurality of sound absorption grooves formed there upon.

3. The phasing plug of claim 1, wherein the sound absorbing insert is fabricated from rubber, cork or high-density foam.

4. The phasing plug of claim 1, further comprising a wave guide array integrally formed with said outlet region.

5. The phasing plug of claim 1, wherein said sound wave pathways volumetrically expand from said inlet apertures to said annular outlet apertures of said phasing plug.

6. The phasing plug of claim 5, wherein said volumetric expansion is exponential.

7. The phasing plug of claim 1, wherein said central wave guide member, said intermediate wave guide members and said bottom wave guide member are fabricated from a phenolic material.

8. The phasing plug of claim 1, wherein said sound absorbing insert and a first end of said central wave guide member are sized to occupy about the center ⅓ surface area of said phasing plug.

9. The phasing plug of claim 1, wherein said sound wave inlet region comprises about the outer ⅔ circumferential ring area of said phasing plug.

10. The phasing plug of claim 1, wherein said bottom wave guide member further comprises a wave guide surface circumferentially formed upon the outer diameter of a first end of said bottom wave guide member.

11. A compression driver system, comprising:
a phasing plug disposed between a throat of a bottom plate and a diaphragm of said compression driver;
said phasing plug having a central wave guide member, said central wave guide member having a sound absorbing insert received into an integral recess formed on a first end of said central wave guide member, at least one intermediate wave guide member, a bottom wave guide member, wherein each member is sized for co-axially insertion one within the other in a spaced apart relationship; and
a sound wave pathway formed between said central wave guide member and said intermediate wave guide member and said intermediate wave guide member and said bottom wave guide member, said sound pathways extending from a sound wave inlet region adjacent to said diaphragm to an outlet throat region adjacent to said throat.

12. The phasing plug of claim 11, wherein the sound absorbing insert further comprises a plurality of sound absorption groves formed there upon.

13. The phasing plug of claim 11, wherein the sound absorbing insert is fabricated from rubber, cork or high-density foam.

14. The phasing plug of claim 11, further comprising a wave guide array integrally formed with said outlet throat region.

15. The phasing plug of claim 11, wherein said sound wave pathways volumetrically expand from said inlet apertures to said annular outlet apertures of said phasing plug.

16. The phasing plug of claim 15, wherein said volumetric expansion is exponential.

17. The phasing plug of claim 11, wherein said central wave guide member, said intermediate wave guide members and said bottom wave guide member are fabricated from a phenolic material.

18. The phasing plug of claim 11, wherein said sound absorbing insert and a first end of said central wave guide member are sized to occupy about the center ⅓ surface area of said phasing plug.

19. The phasing plug of claim 11, wherein said sound wave inlet region comprises about the outer ⅔ circumferential ring area of said phasing plug.

20. The phasing plug of claim 11, wherein said bottom wave guide member further comprises a wave guide surface circumferentially formed upon the outer diameter of a first end of said bottom wave guide member.

21. A compression driver system, comprising:
a phasing plug disposed between a throat of a bottom plate and a diaphragm of said compression driver;
said phasing plug having a sound wave inlet region formed upon the outer circumferential surface area of said phasing plug and a sound wave absorption region formed upon the remaining centrar surface area of said phasing plug;
a plurality of sound wave pathways formed within said sound wave inlet region, said pathways extending from said sound wave inlet region adjacent to said diaphragm to an outlet throat region adjacent to said throat; and
said diaphragm having a phase coherent energy zone that is located adjacent said sound wave inlet region and a phase distortion zone located adjacent said sound wave absorption region, wherein sound waves generated by the phase coherent energy zone enter said sound wave inlet region and sound waves generated by the phase distortion zone are absorbed by said sound wave absorption region.

22. The phasing plug of claim 21, wherein said sound wave pathways volumetrically expand from said sound wave inlet region to said outlet throat region of said phasing plug.

23. The phasing plug of claim 22, wherein said volumetric expansion is exponential.

24. The phasing plug of claim 21, wherein said sound wave absorption region substantially occupies the center ⅓ surface area of said phasing plug.

25. The phasing plug of claim 11, wherein said sound wave inlet region comprises substantially the outer ⅔ circumferential ring area of said phasing plug.
